(19) United States
(12) Patent Application Publication
(10) Pub. No.: US 2012/0221227 A1
(43) Pub. Date: Aug. 30, 2012

(54) METHOD FOR OPERATING AN INTERNAL COMBUSTION ENGINE

(75) Inventors: Vincenzo ALFIERI, Torino (IT); Alessandro CATANESE, Orbassano (TO) (IT); Raffaele SAGGESE, Torino (IT)

(73) Assignee: GM GLOBAL TECHNOLOGY OPERATIONS LLC, Detroit, MI (US)

(21) Appl. No.: 13/396,716

(22) Filed: Feb. 15, 2012

(30) Foreign Application Priority Data
Feb. 28, 2011 (GB) 1103377.6

(51) Int. Cl. F02D 41/04; F02D 41/30

(52) U.S. Cl. 701/104; 701/103

(57) ABSTRACT

A method for operating an engine includes, but is not limited to acquiring a value of at least one engine operating parameter, using the set of values for determining a predicted value of a combustion parameter indicative of fuel combustion performance within an cylinder, using the values as input of a data-set returning as output a correlated correction value of the combustion parameter, using the correction value and the predicted value for determining an expected value of the combustion parameter, feed-forward controlling an injection of fuel into the engine cylinder targeting the expected value of the combustion parameter, measuring a value of the combustion parameter within the cylinder due to that injection of fuel, using a difference between the expected value and the measured value of the combustion parameter for correcting the correction value of the data-set that is correlated to the set of engine operating parameter values.

### CROSS-REFERENCE TO RELATED APPLICATION

This application claims priority to British Patent Application No. 1103377.6, filed Feb. 28, 2011, which is incorporated herein by reference in its entirety.

### TECHNICAL FIELD

The technical field relates to a method for operating an internal combustion engine, principally an internal combustion engine of a motor vehicle, such as for example a Diesel engine, a gasoline engine, or a gas engine.

### BACKGROUND

It is known that modern internal combustion engines generally comprise a plurality of cylinders, each of which is provided with a dedicated fuel injector for injecting fuel directly into the respective cylinder. The fuel injection can be performed by means of a single injection pulse per engine cycle, or more often by means of a plurality of injection pulses per engine cycle, according to a multi-injection pattern, which comprises at least a pilot injection pulse followed by a main injection pulse.

The fuel injection is defined by several injection parameters, such as for example the Start Of Injection (SOI), the fuel injected quantity, the Energizing Time (ET) of the fuel injector for each injection pulse, and the Dwell Time (DT) between two consecutive injection pulses. These injection parameters, together with other engine operating parameters, such as for example, the engine speed, the intake air pressure and the intake air temperature, determine the performance of the combustion inside the engine cylinder during the engine cycle. Thereby affecting the parameters related thereto, including for example the Start-of-Combustion (SOC), the crank angle at which a fraction of 50% of the injected fuel has burnt (MFB50), the location of a peak pressure (LPP), and the indicated mean effective pressure (IMEP).

In order to increase engine efficiency and to reduce pollutant emissions, principally emission of nitrogen oxides (NOx) and particulate matter (PM), an effective control is generally needed of the combustion performance. According to the state of the art, a known strategy to control the combustion performance provides for measuring the pressure inside the engine cylinder, for using this measured pressure to calculate an actual value of the angular position of the center of combustion (MFB50), and for using the actual value of the MFB50 in a closed-loop control circuit. A controller regulates the start of the main injection pulse, in order to minimize the error between a desired value of the MFB50 and the actual one. A drawback of this strategy is that the actual value of MFB50 can be measured only after the combustion happens, so that the closed-loop control circuit is only able to regulate the start of the main injection pulse of the next engine cycle, when the engine operating conditions can be changed. As a consequence, the response of the closed-loop control circuit is generally too slow to provide an effective combustion control in case of fast changing operating conditions, as usually happens in automotive applications during transients.

In order to dodge this technical problem, feed-forward control strategies of the combustion have been proposed. These strategies are generally based on one of the well-known combustion state models that are currently available for estimating the combustion performance within the engine cylinder, usually quantified in terms of MFB50, as a function of the injection parameters and the engine operating conditions. By way of example, a known feed-forward control strategy provides for using a mathematical inversion of that combustion state model, in order to determine the value of the Start of Injection (SOI) necessary to achieve a desired value of the MFB50.

Another feed-forward control strategy provides for using that combustion state model in order to predict a value of the MFB50 as a function of the engine operating conditions and of a preset value of the start of injection. Then, using the predicted value of the MFB50 and the corresponding preset value of a start of injection to determine a value of the start of injection. The value corresponds to a desired value of the MFB50, using a linear relationship between the MFB50 and the start of the injection. However, every combustion state model is generally calibrated for internal combustion engines that work in ideal operating state, typically internal combustion engines that are brand new and operating properly, while it does not take into account any deviation in the combustion process, which can be due to production spread or ageing of the engine components.

This is true also for the empirically determined map that in several cases replaces the combustion state model in the above mentioned feed-forward control strategies. Consequently, the impact of the production spread and ageing of the engine components is generally disregarded by the known feed-forward control strategies, thereby progressively leading to an inaccurate control of the fuel injections that reduces the engine performance and increases the pollutant emissions.

At least one object is to solve this drawback to improve the accuracy of the mentioned feed-forward control strategies. At least another object is to provide a feed-forward control strategy that is reliable during the whole life of the internal combustion engine. Still another object is to attain the above-mentioned goals with a simple, rational, and rather inexpensive solution. In addition, other objects, desirable features, and characteristics will become apparent from the subsequent summary and detailed description, and the appended claims, taken in conjunction with the accompanying drawings and this background.

### SUMMARY

An embodiment provides a method for operating an internal combustion engine. The method comprises acquiring a value of one or more engine operating parameters, namely a value of each engine operating parameter that is considered. The method also comprises using the acquired set of values, which can comprise just one value, if only one engine operating parameter is considered, or a plurality of values if more than one engine operating parameter is considered, for determining a predicted value of a combustion parameter indicative of a fuel combustion performance within a cylinder of the engine. The method further comprises, using the acquired set of values as input of a data set returning as output a correlated correction value of the combustion parameter and using the correction value and the predicted value for determining an expected value of the combustion parameter. The method also comprises feed-forward controlling an injection of fuel into the engine cylinder targeting the expected value of the combustion parameter and measuring a value of the combustion parameter within the engine cylinder due to that injection of fuel. Lastly, the method comprise using a difference between the expected value and the measured value of the combustion parameter for correcting the correction value of the data-set which is correlated to the acquired set of engine operating parameter values. In this way, the data set containing the correction values of the combustion parameter is updated over the time based on the actual deviation between the expected value and the measured value of the combustion parameter. As a consequence, this data-set constitutes an adaptive block capable to compensate for the impact that the production spread and the aging of the engine components have on the fuel combustion, thereby guaranteeing the reliability of the engine operating method during the whole life of the internal combustion engine.

According to an embodiment, the expected value of the combustion parameter is determined by adding the correction value to the predicted value of the combustion parameter. This embodiment has the advantage of providing a reliable and simple determination of the expected value, with a small computational effort.

According to another embodiment, the correction value is corrected by adding thereto the difference between the expected value and the measured value of the combustion parameter. This embodiment advantageously provides that the data set contain correction values calibrated on the current working conditions of the engine. An embodiment provides that the predicted value of the combustion parameter is determined through a predictive model, which receives as input the acquired set of engine operating parameter values and returns as output the predicted value of the combustion parameter. This predictive model has the advantage of requiring a rather small empirical activity to be calibrated and a rather small computational effort to be implemented.

According to an embodiment, the one or more engine operating parameters are chosen among engine speed, a quantity of fuel to be injected, and parameters directly related thereto. The effects that these engine operating parameters have on the combustion are generally affected by the production spread and aging of the engine components, so that they advantageously allow obtaining a reliable data-set of correction values.

According to another embodiment, the predicted value of the combustion parameter can be determined using not only the acquired set of values, but also a value of one or more additional engine operating parameters, namely a value of each additional engine operating parameter. By way of example, these additional engine operating parameters can be chosen among a start of injection of a main injection pulse, a value of an intake pressure, a value of an intake temperature, a value of an energizing time of the main injection pulse. In this way, it is advantageously possible to obtain a more reliable predicted value of the combustion parameter.

According to still another embodiment, the combustion parameter is a crank angle at which a given fraction of the injected fuel has burnt, for example the crank angle at which a fraction of approximately 50% of the injected fuel has burnt (MFB50). This crank angle has the advantage of being a reliable parameter of the combustion performance.

An embodiment provides that the injection of fuel is feed-forward controlled through that comprises setting a desired value of the combustion parameter. The feed-forward control also comprises and using the expected value of the combustion parameter and a corresponding value of a start of injection to determine a value of the start of injection corresponding to the desired value of the combustion parameter using a polynomial relationship. This includes, for example, a simple linear relationship, between the combustion parameter and the start of the injection. The feed-forward control also comprises starting the fuel injection at the determined value of the start of injection. At least one advantage is that it does not need a complex mathematical inversion of the predictive combustion model, in order to calculate the desired start of injection from the expected value of the combustion parameter.

According to an embodiment, the determined value of the start of injection is corrected using a feed-back control seeking to minimize an error between the desired value and the measured value of the combustion parameter. At least one advantage is that this complements the feed-forward control with a feed-back control of the engine.

The methods can be carried out with the help of a computer program comprising a program-code for carrying out all the steps of the methods described above, and in the form of a computer program product comprising the computer program. The computer program product can be embodied as an internal combustion engine (ICE), comprising an engine block and cylinder head housing a coolant circuit, at least one sensor associated with the ICE and configured to generate a signal proportional to an engine operating parameter. This may include a coolant level, a coolant temperature, and a block temperature. An engine control unit (ECU) can be coupled to the sensor and configured to receive the signal and send an output signal to control the ICE. The ECU includes a microprocessor and a data carrier, and the computer program (OBD software) is stored in the data carrier, which is in communication with the microprocessor such that the microprocessor may execute the computer program and the method described above is carried out. The method can be also embodied as an electromagnetic signal. The signal is modulated to carry a sequence of data bits that represent a computer program to carry out all steps of the method.

### BRIEF DESCRIPTION OF THE DRAWINGS

The present invention will hereinafter be described in conjunction with the following drawing figures, wherein like numerals denote like elements, and:

FIG. 1 is a schematic representation of the steps involved in an embodiment;

FIG. 2 illustrates the relationship between start of injection (SOI) and the angular position of the center of combustion (MFB50) in an internal combustion engine; and

FIG. 3 illustrates the relationship between start of injection (SOI) and the angular position of the center of combustion (MFB50) in a range for use in an embodiment.

### DETAILED DESCRIPTION

The following detailed description is merely exemplary in nature and is not intended to limit application and uses. Furthermore, there is no intention to be bound by any theory presented in the preceding background or summary or the following detailed description.

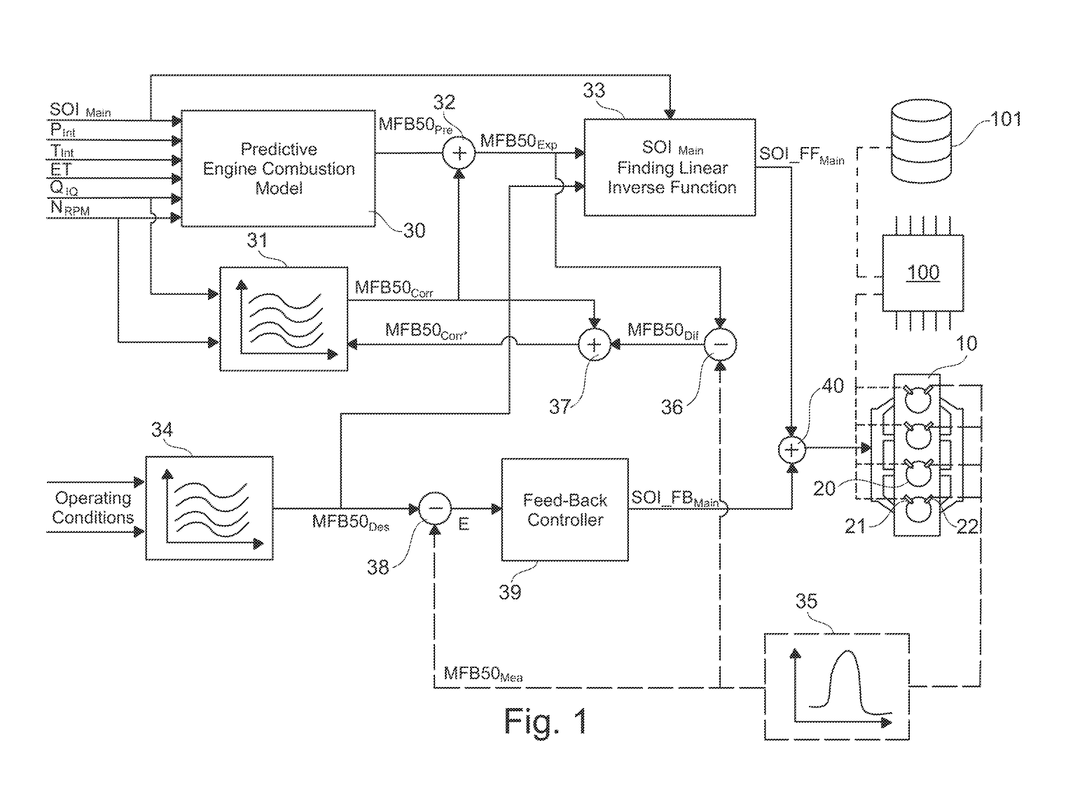

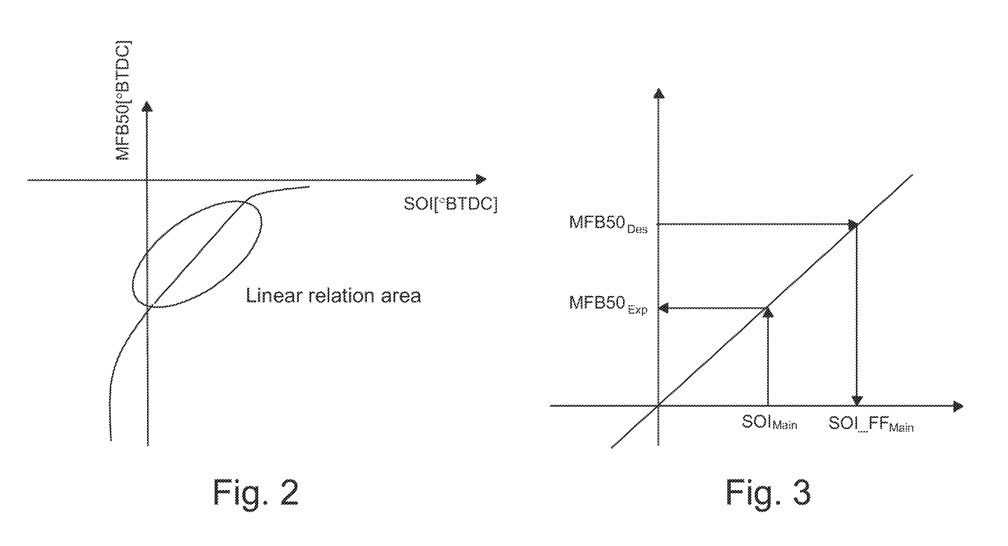

FIG. 1 shows an internal combustion engine 10 that schematically comprises a plurality of cylinders 20, each of which is provided with a dedicated fuel injector 21 for injecting fuel directly into the respective cylinder 20 and with a pressure sensor 22 for measuring the pressure therein. Alternatively, the internal combustion engine 10 could comprise a single pressure sensor 22 arranged to measure the pressure in just one cylinder 20, and the measures of this pressure sensor 22 could be used as an estimation of the pressure inside the other cylinders 20 during the same engine cycle.

In any case, the fuel injectors 21 and the pressure sensor(s) 22 are connected to an engine control unit (ECU) 100, which is provided for operating the internal combustion engine 10. With regard to the present embodiment of the invention, the ECU 100 is provided for operating an injection of fuel per engine cycle in each cylinder 20. The fuel injection is performed according to a multi-injection pattern, which comprises at least a pilot injection pulse followed by a main injection pulse.

According to an embodiment, the main injection pulse is operated with the aid of a feed-forward strategy that comprises the following steps. The first steps provides for acquiring a value of a plurality of engine operating parameters that affect the combustion of the fuel in the cylinder 20. In the present example, the strategy provides for acquiring a set point value SOIMain of the start of injection of the main injection pulse, a value PInt of the intake pressure, a value TInt of the intake temperature, a value ET of the energizing time of the main injection pulse, a value QIQ of the fuel quantity to be injected, and a value NRPM of the engine speed. These acquired values are applied as input to a predictive combustion model 30, which calculates and returns as output a predicted value of a combustion parameter indicative of a combustion performance within the cylinder 20, in this case a predicted value MFB50Pre of the center of combustion, namely the crack angle (MFB50) at which the 50% of the fuel injected quantity has burnt.

The predictive combustion model 30 can be any model known in the art to predict the heat released by a combustion process within an engine cylinder. At the same time, the acquired value QIQ of the fuel quantity to be injected and the acquired value NRPM of the engine speed are also applied as input to a data-set 31, which correlates each couple of these values to a corresponding correction value of the above named combustion parameter, namely a correction value MFB50Corr of the MFB50. The correction value MFB50Corr is provided as output by the data-set 31 and it is fed to an adder 32, which adds the correction value MFB50Corr to the predicted value MFB50Pre provided by the predictive combustion model 30, in order to calculate an expected value MFB50Exp of the MFB50.

The expected value MFB50Exp is then fed to a linear calculation block 33, which receives as input also the acquired set point value SOIMain of the start of injection and a desired value MFB50Des of the MFB50. The desired value MFB50Des is provided by a map 34 that correlates a set of current values of a plurality of engine operating parameters with a corresponding desired value MFB50Des of the MFB50 for such set of values.

In the present example, this set of engine operating parameter values comprises the value NRPM of the engine speed and the value QIQ of the fuel quantity to be injected. Using the expected value MFB50Exp of the MFB50, the set point value SOIMain of the start of injection and the desired value MFB50Des of the MFB50, the linear calculation block 33 calculates as output a value SOI_FFMain of the start of injection such as, if the fuel injector 21 is operated according to this value SOI_FFMain of the start of injection, the combustion of the injected fuel should obtain the desired value MFB50Des of the MFB50.

The calculation of the value SOI_FFMain of the start of injection is performed under a linearity hypothesis as illustrated in FIG. 3, namely the fact that, in a certain operating range, the relationship between SOI and MFB50 can be assumed linear, if all other engine parameters are considered fixed. In this way, it is possible to invert, for each engine cycle, this linear function in order to compute the SOI_FFMain related to a desired MFB50Des value (see FIG. 3).

The slope of the relation between SOI and MFB50 can be in a first approximation assumed equal to one. Higher accuracy may be achieved with a calibratable slope (function of the engine operating conditions) and obtained from experimental results. In order to increase the accuracy, the linear relationship can be replaced by a more complex polynomial relationship.

As a matter of course, the fuel injector 21 is finally commanded in order to perform a main injection pulse having the determined value SOI_FFMain of the start of injection. During the combustion of the injected fuel, the pressure sensor 22 measures the pressure within the cylinder 20 and feeds the pressure signal to a conversion block 35, which converts the pressure signal from the cylinder 20 into a measured angular position MFB50Mea of the center of combustion for that cylinder 20.

This measured value MFB50Mea of the MFB50 is fed to an adder 36, which calculates the difference MFB50D if between the measured value MFB50Mea and the expected value MFB50Exp of the MFB50. This difference MFB50D if can be properly filtered in order to disregard unreliable values, is then fed to an adder 37, where this difference MFB50Dif is added to the correction value MFB50Corr of the MFB50 corresponding to the previously acquired values NRPM of the engine speed and QIQ of the fuel quantity to be injected. Thereby, obtaining an updated correction value MFB50Corr* for that couple of values which finally is memorized in the data-set 31 instead of the preceding correction value MFB50Corr. In this way, during the whole life of the internal combustion engine 10, the correction values stored in the data-set 31 are updated over the time, one correction value per cylinder is updated at each engine cycle, thereby allowing compensating for the impact that the production spread and the aging of the engine components have on the fuel combustion.

As shown in FIG. 1, the measured value MFB50Mea of the MFB50 is also fed-back in closed loop to an adder 38, which calculates the error E, namely the difference, between the desired value MFB50Des of the MFB50 and the measured value MFB50Mea. This error E is fed to a controller 39 provided for generating a correction value SOI_FBMain of the start of the injection of the main injection pulse, which is added by an adder 40 to the previously determined value SOI_FFMain of the start of injection, in order to minimize the error E. In fact, this closed loop control of the angular position of the center of combustion (MFB50) allows adjusting the start of main injection, in order to avoid unstable combustion and to provide more robustness in terms of environmental conditions, engine ageing, and drift components.

The various embodiments of the method described above can be performed with the help of a computer program comprising a program-code for carrying out all the steps of the method. This computer program may be stored in a data carrier 101 associated to an engine control unit (ECU) 100 of the engine 10.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents.

What is claimed is:

1. A method for operating an internal combustion engine, comprising:
acquiring a set of values for a plurality of engine operating parameters;
determining a predicted value of a combustion parameter that is indicative of a fuel combustion performance within a cylinder of the internal combustion engine using the set of values;
using the set of values as input of a data-set returning as an output of a correlated correction value of the combustion parameter;
determining an expected value of the combustion parameter using the correction value;
feed-forward controlling an injection of fuel into the cylinder targeting the expected value of the combustion parameter;
measuring a value of the combustion parameter within the cylinder due to the injection of fuel; and
correcting the correction value of the data-set that is correlated to the set of values for the plurality of engine operating parameters using a difference between the expected value and the measured value of the combustion parameter.

2. The method according to claim 1, wherein the determining the expected value of the combustion parameter comprises adding the correction value to the predicted value of the combustion parameter.

3. The method according to claim 2, wherein the determining the correction value comprises adding the difference between the expected value and the measured value of the combustion parameter.

4. The method according to claim 1, wherein the determining the predicted value of the combustion parameter comprises
receiving as input the set of engine operating parameter values; and
returning as output the predicted value of the combustion parameter.

5. The method according to claim 1, wherein at least one engine operating parameter of the plurality of engine operating parameters is engine speed.

6. The method according to claim 1, wherein at least one engine operating parameter of the plurality of engine operating parameters is a quantity of injected fuel.

7. The method according to claim 1, wherein the determining the predicted value of the combustion parameter comprises using a value of an additional engine operating parameter of the plurality of engine operating parameters.

8. The method according to claim 7, wherein these additional engine operating parameters is a start of injection of a main injection pulse.

9. The method according to claim 7, wherein these additional engine operating parameters is a value of an intake pressure.

10. The method according to claim 7, wherein these additional engine operating parameters is a value of an intake temperature.

11. The method according to claim 7, wherein these additional engine operating parameters is a value of an energizing time of the main injection pulse.

12. A method according to claim 1, wherein the combustion parameter is a crank angle at which a given fraction of the injected fuel has burnt.

13. A method according to claim 1, wherein the injection of fuel is feed-forward control comprising:
setting a desired value of the combustion parameter,
determining a value of the start of injection corresponding to the desired value of the combustion parameter using a polynomial relationship between the combustion parameter and the start of the injection using the expected value of the combustion parameter and a corresponding value of a start of injection; and
starting the fuel injection at the value of the start of injection.

14. A method according to claim 13, wherein the value of the start of injection is corrected using a feed-back control seeking to minimize an error between the desired value and the measured value of the combustion parameter.

15. A computer readable medium embodying a computer program product, said computer program product comprising:
an operating program for operating an internal combustion engine, the operating program configured to:
acquire a set of values for a plurality of engine operating parameters;
determine a predicted value of a combustion parameter that is indicative of a fuel combustion performance within a cylinder of the internal combustion engine using the set of values;
use the set of values as input of a data-set returning as an output of a correlated correction value of the combustion parameter;
determine an expected value of the combustion parameter using the correction value;
feed-forward control an injection of fuel into the cylinder targeting the expected value of the combustion parameter;
measure a value of the combustion parameter within the cylinder due to the injection of fuel; and
correct the correction value of the data-set that is correlated to the set of values for the plurality of engine operating parameters using a difference between the expected value and the measured value of the combustion parameter.

16. The computer readable medium embodying the computer program product according to claim 15, wherein operating program is configured to determine the expected value of the combustion parameter by adding the correction value to the predicted value of the combustion parameter.

17. The computer readable medium embodying the computer program product according to claim 15, wherein the operating program is configured to determine the correction value by adding the difference between the expected value and the measured value of the combustion parameter.

18. The computer readable medium embodying the computer program product according to claim 15, wherein the operating program is configured to:
receive as input the set of engine operating parameter values; and
return as output the predicted value of the combustion parameter.

19. The computer readable medium embodying the computer program product according to claim 15, wherein at least one engine operating parameter of the plurality of engine operating parameters is engine speed.

20. The computer readable medium embodying the computer program product according to claim 15, wherein at least one engine operating parameter of the plurality of engine operating parameters is a quantity of injected fuel.
